(19) United States
(12) Patent Application Publication
(10) Pub. No.: US 2026/0172445 A1
(43) Pub. Date: Jun. 18, 2026

(54) GATEWAY, VEHICLE CONTROL SYSTEM, AND METHOD THEREOF

(71) Applicants: HYUNDAI MOTOR COMPANY, Seoul (KR); KIA CORPORATION, Seoul (KR)

(72) Inventor: Yun Keun Song, Hwaseong-si (KR)

(73) Assignees: HYUNDAI MOTOR COMPANY, Seoul (KR); KIA CORPORATION, Seoul (KR)

(21) Appl. No.: 19/227,094

(22) Filed: Jun. 3, 2025

(30) Foreign Application Priority Data
Dec. 13, 2024 (KR) 10-2024-0186423

(51) Int. Cl. H04L 9/40; H04W 4/021; H04W 4/029; H04W 4/44

(52) U.S. Cl. CPC H04L 63/1441; H04L 63/0823; H04L 63/12; H04W 4/021; H04W 4/029; H04W 4/44

(57) ABSTRACT

A gateway includes a memory configured to store computer-executable instructions and a processor configured to execute the computer-executable instructions. The processor is configured to receive, from a back-end server, a geofencing certificate for verifying whether a vehicle is within a predetermined geofence from a back-end server. The processor is also configured to obtain geofencing information from the geofencing certificate, based on performing a verification of the geofencing certificate based on a digital signature, The processor is additionally configured to determine whether to activate a security function of the vehicle based on a comparison between location information of the vehicle and the geofencing information.

### CROSS-REFERENCE TO RELATED APPLICATION

This application claims the benefit of and priority to Korean Patent Application No. 10-2024-0186423, filed on Dec. 13, 2024, the entire contents of which are hereby incorporated herein by reference.

### TECHNICAL FIELD

The present disclosure relates to a gateway, a vehicle control system, and a method thereof.

### BACKGROUND

A modern vehicle has connectivity with a sophisticated electronic system. With the development of technology, there has been an increase in possibility of cybersecurity threats. The cybersecurity threats may affect an electronic control unit (ECU), a communication network, software, or the like of a vehicle to pose a serious risk to the safety of the vehicle and the life and property protection of a passenger. Particularly, the necessity of complying with cybersecurity requirements of the vehicle is emerging via international regulations, such as UNR No.155 enacted by the United Nations Economic Commission for Europe (UNECE).

A cybersecurity function installed the vehicle becomes an essential element to mitigate these threats and ensure the safety of the vehicle and the passenger. The security function may be activated in a production process and after the release and delivery of the vehicle, but may have the following problems. First, if the security function is immediately activated in the production process of the vehicle, as restriction occurs due to the security function in a function and state inspection process of the vehicle, the efficiency of the production process may be degraded. Secondly, if the vehicle is released in a state in which the security function is deactivated in the production process, there is a possibility that the vehicle will be exposed to cybersecurity threats until a time point when the vehicle is delivered to a customer. This may hinder the safety of the vehicle and the passenger and may lead to a legal problem by a cyberattack.

The matters described in this Background section are only intended to enhance understanding of the background of the present disclosure. Therefore, the Background section may contain information that does not form prior art that is already known to those having ordinary skill in the art to which the present disclosure pertains.

### SUMMARY

The present disclosure has been made to solve the above-mentioned problems occurring in the prior art while advantages achieved by the prior art are maintained intact.

Aspects of the present disclosure provide a gateway, a vehicle control system, and a method for verifying a geofencing certificate and determining whether to activate a security function of a vehicle via comparison between geofencing information with location information of the vehicle to maintain production efficiency in a production factory using the location information of the vehicle and activate the security function when (e.g., immediately after) the vehicle deviates from a trusted factory area.

Another aspect of the present disclosure provides a gateway for setting a geofence with respect to a trusted factory area of a vehicle manufacturer and automatically activating a security function, if a vehicle deviates from the geofence, to increase production efficiency and security, a vehicle control system, and a method thereof.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a gateway is provided. The gateway includes a memory configured to store computer-executable instructions and a processor configured to execute the computer-executable instructions. The processor is configured to receive a geofencing certificate for verifying whether a vehicle is within a predetermined geofence from a back-end server. The processor is also configured to obtain geofencing information from the geofencing certificate, based on performing a verification of the geofencing certificate based on a digital signature. The processor is additionally configured to determine whether to activate a security function of the vehicle based on a comparison between location information of the vehicle and the geofencing information.

In an embodiment, the processor may be configured to transmit a message for requesting to generate the geofencing certificate to the back-end server, determine ignition activation of the vehicle based on receiving the geofencing certificate from the back-end server, and perform the verification of the geofencing certificate based on determining that an ignition of the vehicle is activated.

In an embodiment, the processor may be configured to perform first verification of the geofencing certificate based on at least one of a validity period of the geofencing certificate, identification information of a user who issues the geofencing certificate, an algorithm which is the basis of generation of the geofencing certificate, or any combination thereof. The processor may also be configured to perform second verification of the geofencing certificate based on at least one of a state of the geofencing certificate, a certificate revocation list (CTL) of the geofencing certificate, an online certificate state protocol (OCSP) of the geofencing certificate, or any combination thereof. The processor may further be configured to perform third verification of the geofencing certificate based on at least one of a digital signature included in the geofencing certificate, a digital signature determined from a manufacturer of the vehicle, or any combination thereof. The processor may be configured to perform the verification of the geofencing certificate based on at least one of the first verification, the second verification, the third verification, or any combination thereof.

In an embodiment, the processor may be configured to obtain permitted location information indicating a target area where a trusted factory is located., The processor may also be configured to determine whether a location of the vehicle is in the target area, based on performing a comparison between the location information of the vehicle and the permitted location information.

In an embodiment, the processor may be configured to determine the security function of the vehicle as deactivation, based on determining that the location of the vehicle is in the target area. The processor may also be configured to determine the security function of the vehicle as activation, based on determining that the location of the vehicle is in an area different from the target area and the security function of the vehicle is deactivated.

In an embodiment, the processor may be configured to obtain the permitted location information from the geofencing certificate.

In an embodiment, the processor may be configured to perform the verification of the geofence certificate based on a hash code of the geofencing certificate.

According to another aspect of the present disclosure, a vehicle control system is provided. The vehicle control system includes a back-end server and a gateway. The back-end server is configured to generate a geofencing certificate based on a message requesting to generate the geofencing certificate received from the gateway, and transmit the geofencing certificate to the gateway, based on a verified result obtained as verification of the geofencing certificate is performed via a hash code of the geofencing certificate.

In an embodiment, the back-end server may be configured to obtain permitted location information indicating a target area where a trusted factory is located. The back-end server may be configured to include the permitted location information in the geofencing certificate. The back-end server may be configured to perform the verification of the geofencing certificate, based on at least one of a date when the geofencing certificate is generated, an entity which generates the geofencing certificate, the permitted location information, or any combination thereof. The back-end server may be configured to include a digital signature in the geofencing certificate.

In an embodiment, the back-end server may be configured to obtain the permitted location information from a factory database that includes predetermined permitted location information provided by a manufacturer of the vehicle.

According to yet another aspect of the present disclosure, a vehicle control method is provided. The vehicle control method includes receiving, by a gateway, a geofencing certificate for verifying whether a vehicle is within a predetermined geofence from a back-end server. The vehicle control method also includes obtaining, by the gateway, geofencing information from the geofencing certificate, based performing a verification of the geofencing certificate based on a digital signature. The vehicle control method additionally includes determining, by the gateway, whether to activate a security function of the vehicle based on a comparison between location information of the vehicle and the geofencing information.

In an embodiment, performing the verification of the geofence certificate may include performing the verification of the geofence certificate based on a hash code of the geofencing certificate.

In an embodiment, the vehicle control method may further include transmitting, by the gateway, a message for requesting to generate the geofencing certificate to the back-end server, determining, by the gateway, ignition activation of the vehicle, based on receiving the geofencing certificate from the back-end server, and performing, by the gateway, the verification of the geofencing certificate, based on determining that an ignition of the vehicle is activated.

In an embodiment, performing the verification of the geofence certificate include performing, by the gateway, first verification of the geofencing certificate, based on at least one of a validity period of the geofencing certificate, identification information of a user who issues the geofencing certificate, an algorithm for generation of the geofencing certificate, or any combination thereof. Performing the verification of the geofence certificate may also include performing, by the gateway, second verification of the geofencing certificate, based on at least one of a state of the geofencing certificate, a certificate revocation list (CTL) of the geofencing certificate, an online certificate state protocol (OCSP) of the geofencing certificate, or any combination thereof. Performing the verification of the geofence certificate may additionally include performing, by the gateway, third verification of the geofencing certificate, based on at least one of a digital signature included in the geofencing certificate, a digital signature determined from a manufacturer of the vehicle, or any combination thereof. Performing the verification of the geofence certificate may also include performing, by the gateway, the verification of the geofencing certificate, based on at least one of the first verification, the second verification, the third verification, or any combination thereof.

In an embodiment, determining whether to activate the security function of the vehicle may include obtaining, by the gateway, permitted location information indicating a target area where a trusted factory is located, based on the geofencing information, and determining, by the gateway, whether a location information of the vehicle is the target area, based on performing a comparison between the location information of the vehicle and the permitted location information.

In an embodiment, determining whether to activate the security function of the vehicle may include determining, by the gateway, the security function of the vehicle as deactivation, based on determining that the location of the vehicle is in the target area, and determining, by the gateway, the security function of the vehicle as activation, based on determining that the location of the vehicle is in an area different from the target area and the security function of the vehicle is deactivated.

In an embodiment, obtaining the permitted location information includes obtaining, by the gateway, the permitted location information from the geofencing certificate.

In an embodiment, the vehicle control method may further include generating, by a back-end server, the geofencing certificate, based on a message requesting to generate the geofencing certificate from the gateway, and transmitting, by the back-end server, the geofencing certificate to the gateway, based on performing, by the back-end server, a verification of the geofencing certificate based on the geofencing certificate.

In an embodiment, generating the geofencing certificate includes include obtaining, by the back-end server, permitted location information indicating a target area where a trusted factory is located, including, by the back-end server, the permitted location information in the geofencing certificate, performing, by the back-end server, the verification of the geofencing certificate, based on at least one of a date when the geofencing certificate is generated, an entity which generates the geofencing certificate, the permitted location information, or any combination thereof, and including, by the back-end server, a digital signature in the geofencing certificate.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing illustrating a block diagram of a gateway, according to an embodiment of the present disclosure;

FIG. 2 is a flowchart for describing a vehicle control method, according to embodiment of the present disclosure;

FIG. 3 is a drawing illustrating a gateway and a back-end server, according to an embodiment of the present disclosure;

FIG. 4 is a flowchart for describing a method for generating a geofencing certificate in a vehicle control system, according to an embodiment of the present disclosure;

FIG. 5 is a flowchart for describing a method for determining activation of a security function based on a geofencing certificate in a vehicle control system, according to an embodiment of the present disclosure; and

FIG. 6 is a drawing illustrating a computing system associated with a gateway, a vehicle control system, or a vehicle control method, according to an embodiment of the present disclosure.

With regard to description of drawings, the same or similar components are designated by the same or similar reference signs.

### DETAILED DESCRIPTION

Hereinafter, embodiments of the present disclosure are described in detail with reference to the accompanying drawings. In adding the reference numerals to the components of each drawing, it should be noted that the identical components are designated by the identical reference numerals even when the components are displayed on different drawings. Further, in describing the embodiment of the present disclosure, where it was determined that a detailed description of well-known features or functions would unnecessarily obscure the gist of the present disclosure, the detailed description thereof has been omitted. Various embodiments of the present disclosure are described with reference to the accompanying drawings. However, it should be understood that this is not intended to limit the present disclosure to specific implementation forms. Rather, the present disclosure includes various modifications, equivalents, and/or alternatives of the described embodiments. With regard to description of drawings, similar components may be marked by similar reference numerals.

In the following description, terms first, second, A, B, (a), (b), and the like may be used. These terms are only used to distinguish one component from another component. These terms do not limit the corresponding components irrespective of the order or priority of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equivalent to the contextual meanings in the relevant field of art, and should not be interpreted as having ideal or excessively formal meanings unless clearly defined as having such in the present application. For example, the terms, such as “first”, “second”, “1st”, “2nd”, or the like used in the present disclosure may be used to refer to various components regardless of the order and/or the priority and to distinguish one component from another component, but do not limit the components. For example, “a first user device” and “a second user device” may indicate different user devices regardless of the order or priority thereof. For example, without departing the scope of the present disclosure, a first component may be referred to as a second component, and similarly, a second component may be referred to as a first component.

In the present disclosure, the expressions “have”, “may have”, “include” and “comprise”, “may include”, “may comprise”, or variations thereof, indicate existence of corresponding features (e.g., components such as numeric values, functions, operations, or parts), but do not exclude presence of additional features.

It should be understood that when a component (e.g., a component) is referred to as being “(operatively or communicatively) coupled with/to” or “connected with/to” another component (e.g., a second component), the component may be directly coupled with/to or connected with/to the other component or one or more intervening components (e.g., a third component) may be present therebetween. In contrast, when a component (e.g., a first component) is referred to as being “directly coupled with/to” or “directly connected with/to” another component (e.g., a second component), it should be understood that there is no intervening component (e.g., a third component) therebetween.

According to the situation, the expression “configured to” used in the present disclosure may be used interchangeably with, for example, the expression “suitable for”, “having the capacity to”, “designed to”, “adapted to”, “made to”, or “capable of”.

The term “configured to” does not necessarily mean “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) that may perform corresponding operations by executing one or more software programs that implement a dedicated processor (e.g., an embedded processor) for performing a corresponding operation or a memory device.

Terms used in the present disclosure are used to describe example embodiments and are not intended to limit the scope of the present disclosure. The terms of a singular form may include plural forms unless the context clearly indicates otherwise. All the terms used herein, which include technical or scientific terms, may have the same meaning that is generally understood by a person having ordinary skill in the art. It should be further understood that terms, that are defined in a dictionary and commonly used, should also be interpreted as is customary in the relevant related art and not in an idealized or overly formal detect unless expressly so defined herein in various embodiments of the present disclosure. In some cases, even if terms are terms which are defined in the present disclosure, the terms may not be interpreted to exclude embodiments of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, server, gateway, and the like may separately embody or be included with a processor and a memory, such as a non-transitory computer readable media, as part of the apparatus.

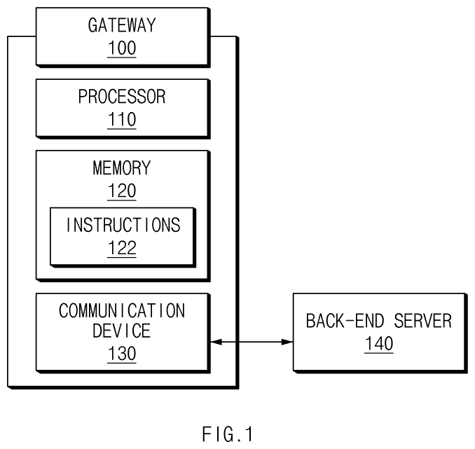

Hereinafter, embodiments of the present disclosure are described in detail with reference to FIGS. 1-6.

FIG. 1 is a drawing illustrating a block diagram of a gateway, according to an embodiment of the present disclosure.

A gateway 100 according to an embodiment may include a processor 110, a memory 120 including instructions 122, and a communication device 130.

The gateway 100 may be a device for activating a security function of a vehicle based on determining that the vehicle leaves, or deviates from, a target area (e.g., geofencing which is a virtual fence) where a trusted factory is located from a manufacturer. For example, the gateway 100 may be a device for activating a security function based on a vehicle location, which may overcome inefficiency in terms of time and cost, such as addition of a production procedure, related equipment introduction, and engineer education capable of occurring on a production process due to the security function in the trusted factory, to reduce cost. The gateway 100 may prevent cybersecurity threats that may occur in a state in which the security function of the vehicle is deactivated, after the vehicle is released, financial damage of a vehicle manufacturer due to cybersecurity breaches, and indirect damage, such as a decline in the manufacturer's image.

The processor 110 may execute software (e.g., in the form of computer-readable instructions). The processor 110 may control at least one other component (e.g., a hardware or software component) connected with the processor 110. In addition, the processor 110 may perform a variety of data processing or computation. For example, the processor 110 may store a geofencing certificate and geofencing information in the memory 120.

For reference, the processor 110 may perform all operations performed by the gateway 100. Therefore, for convenience of description in the specification, the operations performed by the gateway 100 are generally described as operations performed by the processor 110. Furthermore, for convenience of description in the specification, the processor 110 is generally described as one processor. However, the present disclosure is not limited thereto. For example, the gateway 100 may include at least one processor. Each of the at least one processor may at least partially perform all operations associated with an operation of activating the security function of the vehicle.

The memory 120 may temporarily and/or permanently store various pieces of data and/or information required to activate the security function of the vehicle based on geofencing. For example, the memory 120 may store the geofencing certificate and the geofencing information.

The communication device 130 may assist in performing communication between the gateway 100 and a back-end server 140. For example, the communication device 130 may include one or more components for performing communication between the gateway 100 and the back-end server 140. For example, the communication device 130 may include a short range wireless communication unit, a microphone, or the like. At this time, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

In an embodiment, the geofencing certificate may indicate a digital document generated to check a location of the vehicle in a specific geofence and control the security function of the vehicle. The geofencing certificate may be used to verify whether the vehicle is located within a specified geofence. The geofencing certificate may include a digital signature, permitted location information, and a validity period. The digital signature may be a signature for ensuring authenticity and integrity of the certificate and preventing forgery or falsification. The permitted location information may be geographical area information set with respect to the trusted factory by the vehicle manufacturer. The validity period may be used to define an availability period of the geofencing certificate and prevent use of an old certificate. The geofencing certificate may be generated by the back-end server 140. The generated geofencing certificate may be transmitted to the gateway 100 of the vehicle to be used as criteria for activating the security function of the vehicle.

For example, the geofencing information may refer to data associated with a virtual geofence to which the vehicle belongs. The geofencing information may be included in the geofencing certificate and may be used at the core to determine whether the vehicle is within a specific area. The geofencing information may include geographical data and target area data. The geographical data may be data, such as global positioning system (GPS) coordinates or a geofence setting value, that may be used to be compared with a current location of the vehicle to check whether the vehicle is within a corresponding geofence. The target area data may include information associated with a specific area, such as the trusted factory. The geofencing information may be used as basic data for determining whether to activate the security function of the vehicle and may be used to protect the vehicle and a passenger from a security threat.

For example, the target area may refer to a specific geographical location set by the vehicle manufacturer and may be used as a reference point of security and function control. A trusted space where the vehicle should be located, for example, a vehicle manufacturing factory, a maintenance facility, an authenticated workplace, or the like may be set to the target area. The vehicle manufacturer may set a predetermined geofence based on GPS coordinates. The target area may be stored in a factory database of the back-end server 140. The target area may be compared with location information of the vehicle. If the vehicle is within the target area, the security function may be deactivated. On the other hand, if the vehicle leaves or deviates from the target area, the security function of the vehicle may be activated.

In an embodiment, the permitted location information may include detailed data for a trusted geographical area where the vehicle is able to move or operate. The permitted location information may be included in (e.g., be one of the components of) the geofencing certificate, which may be used to control the security function of the vehicle. The permitted location information may include GPS data, which may include longitude and latitude to define an accurate location, and an area fence value which is data for defining a range of the target area. The permitted location information may be predefined by the vehicle manufacturer. The gateway 100 may determine whether to activate the security function depending on the location of the vehicle based on the information.

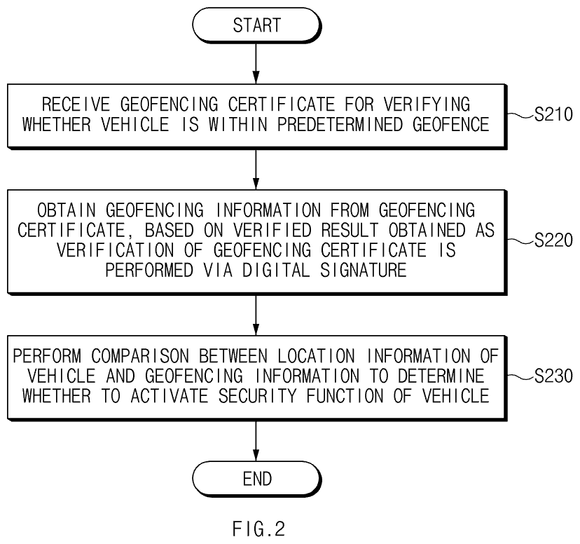

FIG. 2 is a flowchart for describing a vehicle control method, according to embodiment of the present disclosure.

In an operation S210, a processor (e.g., a processor 110 of FIG. 1) according to an embodiment may receive a geofencing certificate for verifying whether a vehicle is within a predetermined geofence from a back-end server (e.g., a back-end server 140 of FIG. 1). In an embodiment, the back-end server may generate the geofencing certificate based on location information. Permitted location information, a digital signature, and the like may be included in the geofencing certificate.

In an operation S220, the processor may obtain geofencing information from the geofencing certificate, based on a verified result obtained as verification of the geofencing certificate is performed via the digital signature.

For example, the verified result may refer to a result derived as the processor checks the digital signature included in the geofencing certificate and checks authenticity and integrity of the geofencing certificate. The processor may check validation of the digital signature included in the geofencing certificate, using a public key provided from a vehicle manufacturer or a certificate authority. The verified result may include a result capable of guaranteeing that the certificate is generated by a trustable server, if the verification succeeds, and a result capable of determining that the certificate is forged or falsified, if the verification fails.

In an operation S230, the processor may perform comparison between location information of the vehicle and the geofencing information to determine whether to activate a security function of a vehicle. For example, after receiving the geofencing certificate, the processor may verify authenticity of the certificate based on the digital signature and may compare the location information of the vehicle with the permitted location information included in the geofencing certificate to check whether the location of the vehicle is included in a specified area.

For example, the processor may check whether the location of the vehicle is included in a specified geofence to activate or deactivate the security function of the vehicle to suit a situation. As a result, the processor may reinforce security of the vehicle and may prevent deterioration in productivity due to an unnecessary security limit.

In an embodiment, the processor may obtain current coordinates of the vehicle from a GPS module or a location tracking sensor mounted on the vehicle. The processor may extract the permitted location information (e.g., location data of a trusted factory) from the verified geofencing certificate. The processor may compare GPS coordinates of the vehicle with the permitted location information to check whether the vehicle is within the specified geofence. The permitted location information may include central coordinates of the geofence and area data in the form of a radius or a polygon. The processor may deactivate the security function if the vehicle is within the geofence, and may activate the security function if the vehicle goes outside of, or deviates, from the geofence.

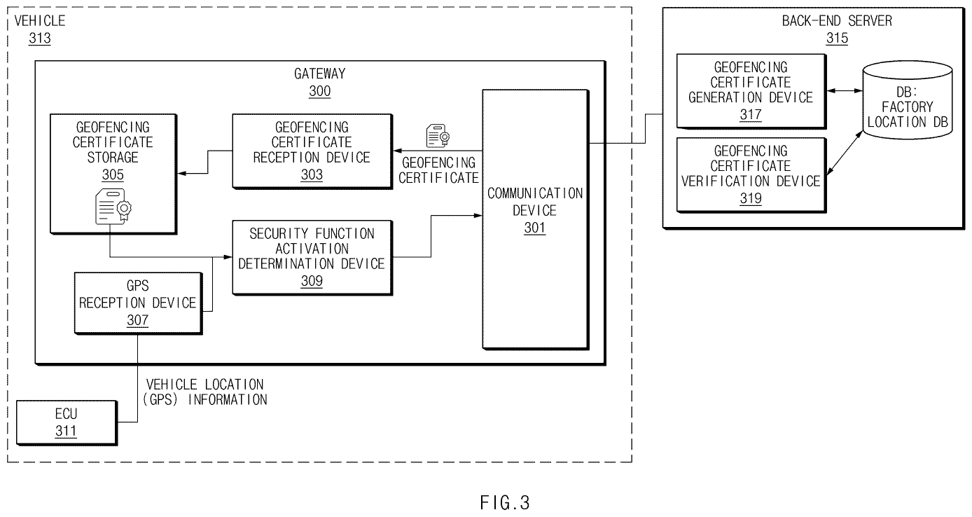

FIG. 3 is a drawing illustrating a gateway and a back-end server, according to an embodiment of the present disclosure.

FIG. 3 illustrates a system configuration and data flow for managing a security function of a vehicle 313 using a geofencing certificate. A vehicle management system may be configured around a gateway 300 included in the vehicle 313 and a back-end server 315 for supporting it.

The gateway 300 may include the following configurations as components for processing and managing security-related data in the vehicle 313.

A communication device 301 may be an interface for transmitting and receiving data with the back-end server 315. The communication device 301 may play a role in requesting and receiving a geofencing certificate and transmitting and receiving related data.

A geofencing certificate reception device 303 may identify the geofencing certificate received from the back-end server 315 and may deliver the geofencing certificate to geofencing certificate storage 305 to internally process the geofencing certificate.

The geofencing certificate storage 305 may store the received geofencing certificate to refer to the geofencing certificate based on verifying the geofencing certificate and determining whether to activate a security function of the vehicle 313 later.

A GPS reception device 307 may play a role in collecting current location information of the vehicle 313. As a result, the gateway 300 may compare the current location information of the vehicle 313 with permitted location information included in the geofencing certificate based on a real-time location of the vehicle 313.

A security function activation determination device 309 may determine whether to activate the security function of the vehicle 313 based on the geofencing certificate and the data obtained from the GPS reception device 307.

The security function activation determination device 309 may deactivate the security function, if the vehicle 313 is within a specified geofence, and may activate the security function, if the vehicle 313 deviates from the geofence.

An ECU 311 may be integrated with various ECUs in the vehicle 313 and may control a security state of the vehicle 313 based on an instruction of the security function activation determination device 309.

The back-end server 315 may play a role in generating a geofencing certificate necessary for the gateway 300 included in the vehicle 313 and performing verification of the geofencing certificate.

A geofencing certificate generation device 317 may generate the geofencing certificate based on a trusted geographical area (e.g., a factory location) including the vehicle 313, with reference to a factory location DB.

A geofencing certificate verification device 319 may perform a digital signature verification protocol and other verification protocols to check integrity and authenticity of the generated geofencing certificate.

The gateway 300 of the vehicle 313 may collect location information of the vehicle 313 via the GPS reception device 307. The gateway 300 may request the back-end server 315 to generate the geofencing certificate via the communication device 301. The back-end server 315 may generate the geofencing certificate based on the location of the vehicle 313 and the factory location DB via the geofencing certificate generation device 317. The geofencing certificate verification device 319 may verify and transmit the geofencing certificate to the gateway 300.

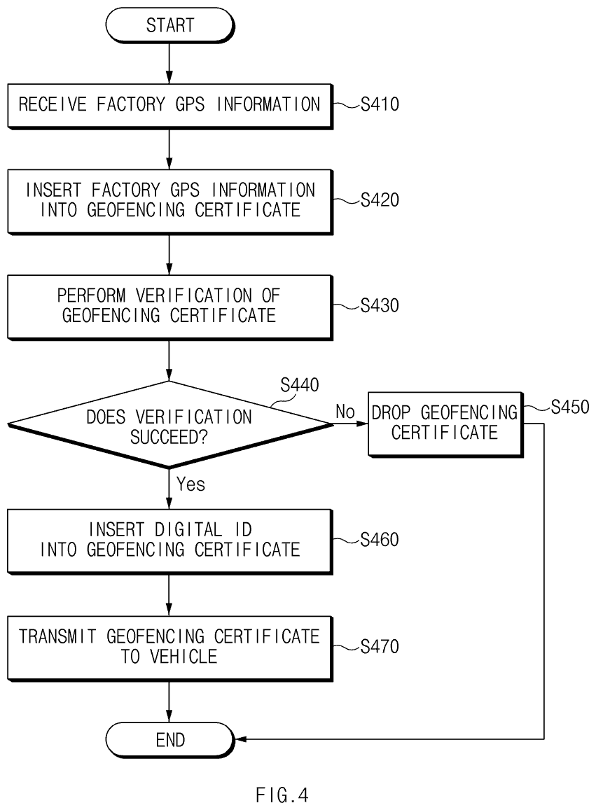

The back-end server 315 may generate the geofencing certificate, based on receiving a message for requesting to generate the geofencing certificate from the gateway 300. The back-end server 315 may transmit the geofencing certificate to the gateway 300, based on a verified result obtained as the verification of the geofencing certificate is performed, for example via a hash code of the geofencing certificate. A detailed description of the operation of generating the geofencing certificate, according to an embodiment, is provided below with reference to FIG. 4.

The gateway 300 may receive the geofencing certificate via the geofencing certificate reception device 303 and may store the geofencing certificate in the geofencing certificate storage 305. The gateway 300 may compare location information of the vehicle 313 with the permitted location information included in the geofencing certificate to determine whether to activate the security function via the security function activation determination device 309. The gateway 300 may control a security system of the vehicle 313 via the ECU 311 depending on whether to activate the security function.

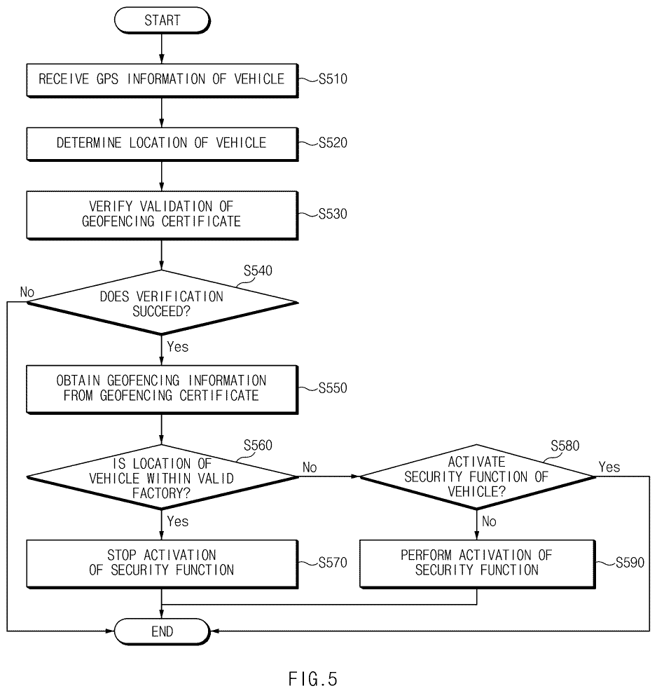

The gateway 300 may transmit the message for requesting to generate the geofencing certificate to the back-end server 315. The gateway 300 may identify ignition activation of the vehicle 313, based on receiving the geofencing certificate from the back-end server 315. The gateway 300 may perform the verification of the geofencing certificate, based on that the ignition of the vehicle 313 is activated. A detailed description of the verification of the geofencing certificate, according to an embodiment, is provided below with reference to FIG. 5.

For convenience of description in the specification, the gateway 300 of FIG. 3 may be described as being the same as a gateway 100 of FIG. 1 and the back-end server 315 of FIG. 3 may be described as being the same as a back-end server 140 of FIG. 1.

FIG. 4 is a flowchart for describing a method for generating a geofencing certificate in a vehicle control system, according to an embodiment of the present disclosure.

Referring to FIG. 4, FIG. 4 is a flowchart illustrating a process of generating and processing a geofencing certificate in a back-end server (e.g., a back-end server 315 of FIG. 3) according to an embodiment.

In an operation S410, the back-end server may receive factory GPS information. For example, the back-end server may obtain GPS information of a trusted factory from a factory database or another source.

In an operation S420, the back-end server may insert the factory GPS information into a geofencing certificate. For example, the back-end server may identify permitted location information indicating a target area where the trusted factory is located, from a factory database predetermined from a manufacturer of a vehicle and may insert the permitted location information into the geofencing certificate. The factory database may store location information of a domestic/foreign production factory and a special factory trustable by the manufacturer of the vehicle. Permitted location information indicating a target area where at least one trusted factory is located may be stored in the geofencing certificate. For reference, the trusted factory may indicate a target trusted from the manufacturer of the vehicle.

In an operation S430, the back-end server may perform verification of the geofencing certificate. For example, the back-end server may perform the verification of the geofencing certificate, via a hash code based on at least one of a date when the geofencing certificate is generated, an entity which generates the geofencing certificate, or the permitted location information, or any combination thereof.

In an operation S440, the back-end server may determine whether the verification of the geofencing certificate succeeds. For example, if the verification succeeds, the back-end server may determine that the geofencing certificate is valid and may perform the next operation. If the verification fails, the back-end server may determine that the geofencing certificate is not valid. In an operation S450, the back-end server may drop the geofencing certificate.

In an operation S460, the back-end server may insert a digital ID (i.e., a digital signature) into the geofencing certificate. For example, as the digital signature of the processor may be added to the geofencing certificate, the verification of which is completed, to ensure authenticity and integrity of the geofencing certificate. The digital signature of the geofencing certificate may be performed in the back-end server by a certificate of the vehicle manufacturer, which is an above certificate.

In an operation S470, the back-end server may transmit the geofencing certificate, the verification of which is completed, to a vehicle. In an embodiment, the vehicle may indicate, but is not limited to, a vehicle located on a production line of the factory.

FIG. 5 is a flowchart for describing a method for determining activation of a security function based on a geofencing certificate in a vehicle control system, according to an embodiment of the present disclosure.

Referring to FIG. 5, FIG. 5 is a flowchart illustrating a process of performing verification of a geofencing certificate and determining activation of a security function of a vehicle in a gateway (e.g., a gateway 300 of FIG. 3) according to an embodiment.

In an operation S510, the gateway may receive GPS information of a vehicle.

In an operation S520, the gateway may determine a location of the vehicle. For example, the gateway may determine the location of the vehicle based on the GPS information of the vehicle.

In an operation S530, the gateway may verify validation of a geofencing certificate. For example, the gateway may perform verification of the geofencing certificate to obtain permitted location information. The verification of the geofencing certificate may be divided into three stages.

For example, the gateway may perform first verification of the geofencing certificate, based on at least one of a validity period of the geofencing certificate, identification information of a user who issues the geofencing certificate, or an algorithm which is the basis of generation of the geofencing certificate, or any combination thereof. In other words, the first verification may be essential basic verification, which may indicate verification for a certificate validity period, an issuer name, and a permitted algorithm.

For example, the gateway may perform second verification of the geofencing certificate, based on at least one of a state of the geofencing certificate, a certificate revocation list (CTL) of the geofencing certificate, or an online certificate state protocol (OCSP) of the geofencing certificate, or any combination thereof. In other words, the second verification may be selective state verification, which may indicate verification for selecting one of certificate state verification, the CRL, or an OCSP scheme.

For example, the gateway may perform third verification of the geofencing certificate, based on at least one of a digital signature included in the geofencing certificate or a digital signature determined from the manufacturer of the vehicle, or any combination thereof. In other words, the third verification may be essential path verification (i.e., verification for a certificate chain), which may indicate signature verification of a vehicle manufacturer certificate and signature verification of the geofencing certificate.

For example, the gateway may perform the verification of the geofencing certificate, based on at least one of the first verification, the second verification, or the third verification, or any combination thereof.

In an operation S540, the gateway may determine whether the verification of the geofencing certificate succeeds. For example, if the verification succeeds, the gateway may determine that the geofencing certificate is valid and may perform the next operation. If the verification fails, the gateway may determine that the geofencing certificate is not valid and may end the operation.

In an operation S550, the gateway may obtain geofencing information from the geofencing certificate. For example, the gateway may obtain permitted location information indicating a target area where a trusted factory is located from the manufacturer of the vehicle, from the geofencing information obtained based on the verified result.

The gateway may determine whether the location information of the vehicle is included in the target area, based on performing comparison between the location information of the vehicle and the permitted location information. For example, in an operation S560, the gateway may determine whether the location of the vehicle is within a valid factory.

If the location of the vehicle is within the valid factory, in an operation S570, the gateway may stop activation of a security function. In other words, if the location information of the vehicle is included in the target area, the gateway may determine the security function of the vehicle as deactivation.

If the location of the vehicle is not within the valid factory, in an operation S580, the gateway may identify whether to activate the security function of the vehicle. For example, if the security function of the vehicle is activated, the gateway may end without performing an additional operation. On the other hand, if it is identified that the security function of the vehicle is not activated, in an operation S590, the gateway may perform activation of the security function. In other words, if the location information of the vehicle is included in an area different from the target area and the security function of the vehicle is deactivated, the gateway may determine the security function of the vehicle as activation.

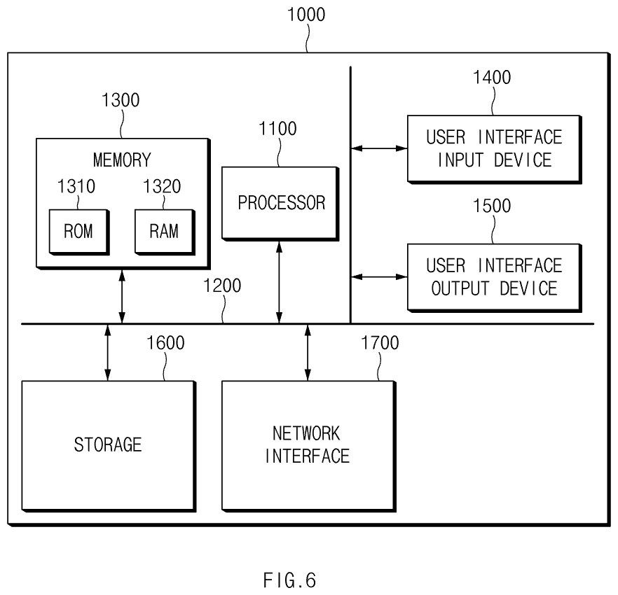

FIG. 6 is a drawing illustrating a computing system associated with a gateway, a vehicle control system, or a vehicle control method according to an embodiment of the present disclosure.

Referring to FIG. 6, a computing system 1000 about the gateway, the vehicle control system, or the vehicle control method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to example embodiments and the accompanying drawings, the present disclosure is not limited thereto. Rather, the described embodiments may be variously modified and altered by those having ordinary skill in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It should be understood by those having ordinary skill in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those having ordinary skill in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like.

The above-described hardware devices may be configured to act as one or a plurality of software modules to perform the operations of the embodiments, or vice versa.

Even though the embodiments are described with reference to restricted drawings, it should be apparent to one of ordinary skill in the art that the embodiments are variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description is given below of the effects of the gateway, the vehicle control system, and the method thereof according to some embodiments of the present disclosure.

According to at least one of embodiments of the present disclosure, the gateway may verify a geofencing certificate and may determine whether to activate a security function of a vehicle via comparison between geofencing information with location information of the vehicle, thus maintaining production efficiency in a production factory using the location information of the vehicle and activating the security function immediately after the vehicle deviates from a trusted factory area.

According to at least one of embodiments of the present disclosure, the gateway may set a geofence with respect to a trusted factory area of a vehicle manufacturer and may automatically activate the security function, if the vehicle deviates from the geofence, thus increasing production efficiency and security.

In addition, various effects ascertained directly or indirectly through the present disclosure may be provided.

Therefore, other implements, other embodiments, and equivalents to claims are within the scope of the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A gateway, comprising:
a memory storing computer-executable instructions; and
a processor configured to execute the computer-executable instructions,
wherein the processor is configured to:
receive, from a back-end server, a geofencing certificate for verifying whether a vehicle is within a predetermined geofence,
obtain geofencing information from the geofencing certificate, based on performing a verification of the geofencing certificate based on a digital signature, and
determine whether to activate a security function of the vehicle based on a comparison between location information of the vehicle with the geofencing information.

2. The gateway of claim 1, wherein the processor is configured to:
transmit a message requesting to generate the geofencing certificate to the back-end server;
determine an ignition activation of the vehicle based on receiving the geofencing certificate from the back-end server; and
perform the verification of the geofencing certificate based on determining that an ignition of the vehicle is activated.

3. The gateway of claim 1, wherein the processor is configured to:
perform first verification of the geofencing certificate, based on at least one of a validity period of the geofencing certificate, identification information of a user who issues the geofencing certificate, an algorithm for generation of the geofencing certificate, or any combination thereof;
perform second verification of the geofencing certificate, based on at least one of a state of the geofencing certificate, a certificate revocation list (CTL) of the geofencing certificate, an online certificate state protocol (OCSP) of the geofencing certificate, or any combination thereof;
perform third verification of the geofencing certificate, based on at least one of a digital signature included in the geofencing certificate, a digital signature determined from a manufacturer of the vehicle, or any combination thereof; and
perform the verification of the geofencing certificate, based on at least one of the first verification, the second verification, the third verification, or any combination thereof.

4. The gateway of claim 3, wherein the processor is configured to:
obtain permitted location information indicating a target area where a trusted factory is located; and
determine whether a location the vehicle is in the target area based on performing a comparison between the location information of the vehicle and the permitted location information.

5. The gateway of claim 4, wherein the processor is configured to:
determine the security function of the vehicle as deactivation based on determining that the location of the vehicle is in the target area; and
determine the security function of the vehicle as activation based on determining that the location of the vehicle is in an area different from the target area and the security function of the vehicle is deactivated.

6. The gateway of claim 4, wherein the processor is configured to obtain the permitted location information from the geofencing certificate.

7. The gateway of claim 4, wherein the processor is configured to perform the verification of the geofence certificate based on a hash code of the geofencing certificate.

8. A vehicle control system, comprising:
a back-end server; and
a gateway,
wherein the back-end server is configured to:
generate a geofencing certificate for a vehicle based on a message requesting to generate the geofencing certificate received from the gateway, and
transmit the geofencing certificate to the gateway based on performing a verification of the geofencing certificate based the geofencing certificate.

9. The vehicle control system of claim 8, wherein the back-end server is configured to perform the verification of the geofence certificate based on a hash code of the geofencing certificate.

10. The vehicle control system of claim 8, wherein the back-end server is configured to:
obtain permitted location information indicating a target area where a trusted factory is located;
include the permitted location information in the geofencing certificate;
perform the verification of the geofencing certificate, based on at least one of a date when the geofencing certificate is generated, an entity that generates the geofencing certificate, the permitted location information, or any combination thereof; and
include a digital signature in the geofencing certificate, based on verifying the geofencing certificate.

11. The vehicle control system of claim 10, wherein the back-end server is configured to obtain the permitted location information from a factory database that includes predetermined permitted location information provided by a manufacturer of the vehicle.

12. A vehicle control method, comprising:
receiving, by a gateway from a back-end server, a geofencing certificate for verifying whether a vehicle is within a predetermined geofence;
obtaining, by the gateway, geofencing information from the geofencing certificate, based on performing a verification of the geofencing certificate based on a digital signature; and
determining, by the gateway, whether to activate a security function of the vehicle based on a comparison between location information of the vehicle and the geofencing information.

13. The vehicle control method of claim 12, wherein performing the verification of the geofence certificate includes performing the verification of the geofence certificate based on a hash code of the geofencing certificate.

14. The vehicle control method of claim 12, further comprising:
transmitting, by the gateway, a message requesting to generate the geofencing certificate to the back-end server;
determining, by the gateway, ignition activation of the vehicle based on receiving the geofencing certificate from the back-end server; and
performing, by the gateway, the verification of the geofencing certificate based on determining that an ignition of the vehicle is activated.

15. The vehicle control method of claim 12, wherein performing the verification of the geofence certificate includes:
performing, by the gateway, first verification of the geofencing certificate, based on at least one of a validity period of the geofencing certificate, identification information of a user who issues the geofencing certificate, an algorithm for generation of the geofencing certificate, or any combination thereof;
performing, by the gateway, second verification of the geofencing certificate, based on at least one of a state of the geofencing certificate, a certificate revocation list (CTL) of the geofencing certificate, an online certificate state protocol (OCSP) of the geofencing certificate, or any combination thereof;
performing, by the gateway, third verification of the geofencing certificate, based on at least one of a digital signature included in the geofencing certificate, a digital signature determined from a manufacturer of the vehicle, or any combination thereof; and
performing, by the gateway, the verification of the geofencing certificate, based on at least one of the first verification, the second verification, the third verification, or any combination thereof.

16. The vehicle control method of claim 12, wherein determining whether to activate the security function of the vehicle includes:
obtaining, by the gateway, permitted location information indicating a target area where a trusted factory is located, based on the geofencing information; and
determining, by the gateway, whether a location the vehicle is in the target area, based on performing a comparison between the location information of the vehicle and the permitted location information.

17. The vehicle control method of claim 16, wherein determining whether to activate the security function of the vehicle includes:
determining, by the gateway, the security function of the vehicle as deactivation, based on determining that the location of the vehicle is in the target area; and
determining, by the gateway, the security function of the vehicle as activation, based on determining that the location of the vehicle is in an area different from the target area and the security function of the vehicle is deactivated.

18. The vehicle control method of claim 16, wherein obtaining the permitted location information includes obtaining, by the gateway, the permitted location information from the geofencing certificate.

19. The vehicle control method of claim 12, further comprising:
generating, by a back-end server, the geofencing certificate, based on a message requesting to generate the geofencing certificate from the gateway; and
transmitting, by the back-end server, the geofencing certificate to the gateway, based on the verification of the geofencing certificate.

20. The vehicle control method of claim 19, generating the geofencing certificate includes:
obtaining, by the back-end server from a factory database, permitted location information indicating a target area where a trusted factory is located;
including, by the back-end server, the permitted location information in the geofencing certificate;
performing, by the back-end server, the verification of the geofencing certificate, based on at least one of a date when the geofencing certificate is generated, an entity which generates the geofencing certificate, the permitted location information, or any combination thereof; and
including, by the back-end server, a digital signature into the geofencing certificate, based on verifying the verification.
